(19) United States
(12) Patent Application Publication
(10) Pub. No.: US 2017/0161766 A1
(43) Pub. Date: Jun. 8, 2017

(54) SYSTEMS AND METHODS FOR AN INTELLIGENT ONLINE SOCIAL COMMERCIAL NETWORK

(71) Applicants: HOOMAN MOTEVALLI ABYAZANI, BREMEN (GE); HOOMAN ELMI KETABFOROOSH, TEHRAN (IR)

(72) Inventors: HOOMAN MOTEVALLI ABYAZANI, BREMEN (GE); HOOMAN ELMI KETABFOROOSH, TEHRAN (IR)

(73) Assignee: HSP Holdings Inc., Bremen (DE)

(21) Appl. No.: 15/344,106

(22) Filed: Nov. 4, 2016

Related U.S. Application Data
(60) Provisional application No. 62/263,451, filed on Dec. 4, 2015.

(51) Int. Cl. G06Q 30/02; G06Q 30/08; G06Q 50/00

(52) U.S. Cl. CPC G06Q 30/0214; G06Q 50/01; G06Q 30/08

(57) ABSTRACT

A system and method for providing solution to a user with a social network or online social commercial network comprises a user module. The user module is configured to control and monitor multiple sub-modules. A feed sub-module is configured to provide access to other users, and receives credits based on the marketing of the product or services. A need sub-module provides an option for inputting a user need, and generate the credits for a user sharing the solutions to the input needs. A bid sub-module is configured to conduct bids, sell, or buy the user accounts for generating the credits to the user account. A lead sub-module comprises a neural network configured to learn, and track one or more user behavior in the system, generating the credits to the user by sharing the behavior to the other users. The system facilitates a social business platform generating credit to the users.

### BACKGROUND OF THE INVENTION

Providing solutions and fulfilling human needs is a well-known social problem. In sum, people have different needs and they are looking for solutions and ways of fulfilling those needs. So far, the problem of acquiring solutions to the needs was accomplished by means of books, seminars, labs, articles, courses, etc.

Online search driven by Web-based search engines has proven to be one of the most significant uses of computer networks such as the Internet. Computer users can employ a variety of search tools to search for content using different user interfaces and search methods. The internet is becoming an increasing mechanism by which people are buying goods and services. Transactions conducted electronically, often in an online environment taking advantage of networks, such as the Internet and/or World Wide Web (“www”), form an increasingly important subset of transactions. Most obviously, retail sales transactions in which individual customers purchase goods or services from a central web server using a www connection have become a prominent form of electronic transactions, though such transactions are by no means the only or even necessarily the predominant category of electronic transactions.

It is well appreciated that an astronomically large number of potential customers, clients or other consumers are available online for buying or otherwise acquiring vendible goods and/or services. The pool of potential online consumers may include all persons as well as public and private corporations, partnerships, governmental organizations and other such entities. Indeed, according to a report by Forrest Research in 2007, online shopping, excluding travel, has become a $175 billion phenomenon in the United States. This large volume of traffic has spawned numerous inventions, but none that adequately address retailing and purchasing by more personalized sophisticated means.

Transactions are increasingly characterized by the amount and quality of information available to market participants. To an extent, however, online transactions are still not very efficient and/or still require much time and effort and an element of trust being extended to unknown sellers and/or providers. For example, if a shopper has an idea to buy a digital camera as a gift, the shopper begins the search online, and after searching for desired characteristics, decides on a brand and model number. She then goes on a comparison-shopping site; types in the model number, and gets a listing of prices from multiple vendors. The process is typically arduous, possibly requiring hours of work, investigation of a diversity of online sites, and at the conclusion of the exercise, the outcome is not always the best combination of price, delivery schedule and so forth for the shopper. Moreover, the complexity grows exponentially if the shopper is trying to secure the best overall price.

Furthermore, electronic transactions pose special challenges for transaction parties. Some of these challenges relate to the difficulty of providing to a prospective acquirer (e.g., a purchaser) of goods or services full, accurate, and verifiable information regarding the nature, value, authenticity, and other suitability-related characteristics of the product in question. This is true in part, for instance, because the customer cannot necessarily handle, sample, or evaluate at first hand the goods or services in question in an online transaction to the same extent to which he could evaluate them in an in-person transaction.

The field of invention is the provision of solutions to human needs with social networking. There are numerous disadvantages of the prior systems and methods. Specifically, they focus on specialized needs. In addition, the solutions are not derived from a large network. Moreover, the prior art solutions did not encourage large amounts of users to participate in addressing needs on a daily bases. Prior art systems and methods did not facilitate the sharing of information with one or more persons who had similar or exactly the same needs as the individual who is now experiencing. Importantly, the prior systems and methods did not provide motivation for people to address needs of other people. Accordingly, there is a need in the art for systems and methods for a generalized need management solution.

Thus, there is a clear and present need for a tool that puts a structure into everyday online needs based activities. There is also a need for a user interface that's not too complicated to navigate (fast response time), and serves the user need of researching, assembling, and pricing the most popular good or service the user is in need of. As alluded to above, there is also a need for a system and method for enhancing trust on the part of participants in a transaction. The transaction may be between a user who needs something or some service and a provider who sells the thing or service being requested. Further, there is a need for an intelligent online social commercial network for providing solution to user needs, which facilitates the sharing of information between the users of similar needs for efficient transaction and analytics in the trading, and business. The system and method should motivate the users to address needs of other users by incorporating a reward module in the system.

### SUMMARY OF THE INVENTION

The present invention relates to a computer-implemented system for providing solution to a user with a social network or online social commercial network. In an embodiment, the web-based online social commercial network is a computer-implemented system, which comprises processor-executable instructions. The said instructions executed by at least one processor, the computer-implemented system comprises a user module, which includes a web server system via a network connection configured to control and monitor one or more sub-modules.

One aspect of the present disclosure is directed to a computer-implemented system for providing solution to a user with a social network, the computer-implemented system having processor-executable instructions stored thereon that, when executed by at least one processor, the computer-implemented system comprising: a user module includes a web server system via a network connection configured to control and monitor one or more sub-modules, wherein the user module comprising: (1) a feed sub-module via a financial management module configured to: (a) provide access to one or more other users or organizations; (b) provide access to one or more partner websites selling products or provide services; and (c) provide a platform for the user to participate in promoting or marketing of one or more product or services, wherein the user receives one or more credits based on the marketing of one or more product or services, (2) a need sub-module configured to: (a) provide an option for inputting one or more needs by the user and creating a list of needs for the user; (b) provide an option of sharing the need or keeping the need private by the user; (c) provide recommendation to one or more groups related to one or more shared needs; (d) provide an option for setting up one or more pre-determined user preferences for the need; (e) filter the recommendations based on the user preferences; (f) providing an option for the users to join the groups providing one or more solutions to the needs, wherein the solutions to the needs are judged by the user or other users to generate the credits for a user offering solutions or sharing the solutions to the input needs, (3) a bid sub-module comprising one or more user accounts managed by the user is configured to: (a) collect one or more data of the user accounts contributing to a bid; (b) compute a selling price based on the data of the user accounts; (c) receive the selling price of the user accounts determined by the user, wherein the user is provided with an option to sell or buy user accounts for generating the credits to the user accounts, a lead sub-module comprising a neural network configured to learn and track one or more user behavior in the system, wherein the behavior is stored in a database of the system, and the user generates the credits by sharing the behavior to other users. In one embodiment, the preamble of said claim is to a computer-implemented system for providing a solution to a user with a social network.

In one embodiment, the user module comprises a feed sub-module, a need sub-module, a bid sub-module, and a lead sub-module. In an embodiment, the feed sub-module is configured to provide access to one or more other users or organizations through a financial management module. In one embodiment, the feed sub-module is configured to provide access to one or more partner websites selling products or providing services. In another embodiment, the feed sub-module is configured to provide a platform for the user to participate in promoting or marketing of one or more product or services. The user receives one or more credits based on the marketing of one or more product or services.

In an embodiment, the need sub-module is configured to provide an option for inputting one or more needs by the user and creating a list of needs for the user. In an embodiment, the need sub-module is configured to provide an option of sharing the user need to other users in the network. In one embodiment, the need sub-module is configured to provide an option of maintaining the user need privately or confidentially with them. In an embodiment, the need sub-module is configured to provide recommendation to one or more groups relevant to one or more shared needs of the user. In one embodiment, the need sub-module is configured to provide an option to provide an option for setting up one or more pre-determined preferences on their specified need by the user. The recommendations could be filtered based on the user preferences on the specified needs. In one embodiment, the need sub-module is configured to provide an option for joining the groups providing one or more solutions to the needs by the user. The solutions to the needs are judged by the user or other users to generate the credits for a user offering solutions or sharing the solutions to the input needs.

In an embodiment, the bid sub-module comprises one or more user accounts managed by the user is disclosed. In one embodiment, the bid sub-module is configured to collect one or more data of the user accounts contributing to a bid. In one embodiment, the bid sub-module in the system computes a selling price of the user accounts based on the data of the user accounts. In another embodiment, the bid sub-module is configured to receive the selling price of the accounts determined by the user. The user is provided with an option to conduct bids, sell, or buy the user accounts for generating the credits to the user account. In an embodiment, the lead sub-module comprises a neural network configured to learn and track one or more user behavior in the system. In one embodiment, the behavior is stored in a database of the system. In another embodiment, the user generates the credits by sharing the behavior to the other users.

In one embodiment, the credit is one or more rewards comprising a gift or a reward point, or a gift voucher, or a cash reward, or one or more discounts. In an embodiment, the feed sub-module is configured to provide access to the partner websites providing services including dating, traveling, shopping, or gaming. In one embodiment, the feed sub-module is configured to provide an option for the users to create groups, pages, advertisements through a financial management module. In an embodiment, the system receives a percentage of transaction, a percentage of profit or a fixed fee from one or more transaction made by the users in the feed module. In one embodiment, the system is configured to provide an option for the user to customize the feed sub-module to a marketing organization.

In one embodiment, the need includes one or more needs of physical, psychological, safety or convenience. In another embodiment, the credit is one or more rewards comprising a reward point, or a gift voucher, or a cash reward, or one or more discounts. In one embodiment, the feed sub-module is configured to provide access to the partner websites providing services including dating, traveling, shopping, or gaming. In another embodiment, the feed sub-module via a financial management module is configured to provide an option for the users to create groups, pages, advertisements. In one embodiment, the system receives a percentage of transaction, a percentage of profit or a fixed fee from one or more transaction made by the users in the feed module. In another embodiment, the system is configured to provide an option for the user to customize the feed sub-module to a marketing organization.

In one example of the computer-implemented system, the need sub-module is configured to share one or more internal web pages or external web pages in the server, or groups related to the needs that have been created and recommended by other users in connection with one or more similar input needs of the user. In another example, the need sub-module is configured to provide an option for the users to search one or more internal web pages or external web pages in the server, or groups related to the needs, which are created and recommended by other users in connection with one or more similar input needs of the user.

In an embodiment, the need sub-module is configured to share one or more internal web pages or external web pages in the server, or groups related to the needs that have been created and recommended by other users in connection with one or more similar input needs of the user. In one embodiment, the need sub-module is configured to provide an option for the users to search one or more internal web pages or external web pages in the server, or groups related to the needs that have been created and recommended by other users in connection with similar input needs of the user. In an embodiment, the need includes one or more needs of physical, psychological, safety, or convenience.

In an embodiment, the bid sub-module is configured to provide an option for the user to buy or sell the user account. In one embodiment, the bid sub-module is configured to compute a selling price of the user account based on one or more data value including records, history, points, or reputations in the user accounts. In another embodiment, the bid sub-module is configured to provide an option for the other user to provide the data value to the user account. In an embodiment, the user behavior is one or more methods or experiences of the user fulfilling the needs. In an embodiment, the lead sub-module comprises an option for users to share one or more methods or experience of fulfilling the needs to other users by providing one or more comments, reviews, or reactions.

In one embodiment, the bid sub-module is configured to provide an option for the user to buy or sell the user account. In another embodiment, the bid sub-module is configured to compute a selling price of the user account based on one or more data value including records, history, points, or reputations in the user accounts. In one embodiment, the bid sub-module is configured to provide an option for the other user to provide the data value to the user account. In another embodiment, the user behavior is one or more methods or experiences of the user fulfilling the needs. In one embodiment, the lead sub-module comprises an option for users to share one or more methods or experience of fulfilling the needs to other users by providing one or more comments, reviews, or reactions.

The present invention also relates to a computer-readable storage medium for providing solution to a user with a social network or online social commercial network. In an embodiment, a computer-readable storage medium having processor-executable instructions stored thereon that, when executed by at least one processors with a web-server system via a network connection using one or more sub-modules. In an embodiment, the first sub-module is configured to provide an access to one or more other users or organizations for the users. In one embodiment, the first sub-module is configured to provide an access to one or more partner web sites selling products or providing services. In another embodiment, the first sub-module is configured to provide a platform for the user to participate in promoting or marketing of one or more product or services by the first sub-module. The user receives one or more credits based on the marketing of one or more product or services in the first sub-module.

In an embodiment according to the present invention, the second sub-module provide an option for inputting one or more needs by the user and creating a list of needs for the user. In one embodiment, the second sub-module provide an option for sharing the need or keeping the need private by the user. In another embodiment, the second sub-module provide a recommendation to one or more groups related to the shared needs. In another embodiment, the second sub-module provide an option for setting up one or more pre-determined user preferences for the needs. The recommendations could be filtered based on the user preferences on the specified needs. In another embodiment, the need sub-module is configured to provide an option for joining the groups providing one or more solutions to the needs by the user. The solutions are judged by the user or other users to generate the credits for a user offering solutions or sharing the solutions to the input needs.

In an embodiment according to the present invention, the third sub-module is configured to collect one or more data of the user accounts contributing to a bid by a third sub-module. In one embodiment, the third sub-module compute a selling price based on one or more data of the user accounts. In another embodiment, the third sub-module is configured to receive the selling price of the user accounts determined by the user. The user is provided with an option to conduct bids, sell or buy user accounts for generating the credits to the user account. In an embodiment according to the present invention, the fourth sub-module is configured to learn and track one or more user behavior via a neural network. The user could generate the credits by sharing the behavior to other users in the system.

Another aspect of the present disclosure is directed to a computer-readable storage medium having processor-executable instructions stored thereon that, when executed by at least one processors with a web-server system via a network connection to: (a) provide an access to one or more other users or organizations for the users by a first sub-module; (b) provide an access to one or more partner websites selling products or providing services by the first sub-module; (c) provide a platform for the user to participate in promoting or marketing of one or more product or services by the first sub-module, wherein the user receives one or more credits based on the marketing of one or more product or services, (d) provide an option for inputting one or more needs by the user and creating a list of needs for the user by a second sub-module; (e) provide an option of sharing the need or keeping the need private by the user by the second sub-module; (f) provide a recommendation to one or more groups related to one or more shared needs by the second sub-module; (g) provide an option for setting up one or more pre-determined user preferences for the need by the second sub-module; (h) filter the recommendations based on the user preferences by the second sub-module; (i) providing an option for the users to join the groups providing one or more solutions to the needs by the user by the second sub-module, wherein the solutions to the needs are judged by the user or other users to generate the credits for a user offering solutions or sharing the solutions to the input needs, (j) collect one or more data of the user accounts contributing to a bid by a third sub-module; (k) compute a selling price based on the data of the user accounts by the third sub-module; (l) receive the selling price of the user accounts determined by the user by the third sub-module, wherein the user is provided with an option to sell or buy user accounts for generating the credits to the user, (m) learn and track one or more user behavior via a neural network by a fourth sub-module, wherein the behavior is stored in a database of the system, and the user generates the credits by sharing the behavior to other users. In one embodiment, the preamble of the claim is a computer-readable storage medium having processor-executable instructions.

In one embodiment of the computer-readable storage medium, the first sub-module is a feed sub-module, the second sub-module is a need sub-module, the third sub-module is a bid sub-module, and the fourth sub-module is a lead sub-module.

The present invention also relates to a method for online social commercial network implemented with a web-server system via a network connection. In an embodiment, the method comprises a computer-implemented system having processor-executable instructions stored thereon that, when executed by at least one processor to provide a plurality of steps using one or more sub-modules. In a step, the first sub-module is configured to provide an access to one or more other users or organizations for the users. In another step, the first sub-module is configured to provide an access to one or more partner websites selling products or providing services. In yet another step, the first sub-module is configured to provide a platform for the user to participate in promoting or marketing of one or more product or services by the first sub-module. In other steps, the user receives one or more credits based on the marketing of one or more product or services in the first sub-module.

In a step according to the present invention, the second sub-module provides an option for inputting one or more needs by the user and creating a list of needs for the user. In another step, the second sub-module provides an option for sharing the need or keeping the need private by the user. In yet another step, the second sub-module provides a recommendation to one or more groups related to the shared needs. In still yet another step, the second sub-module provides an option for setting up one or more pre-determined user preferences for the needs. The recommendations could be filtered based on the user preferences on the specified needs. In other steps, the need sub-module is configured to provide an option for joining the groups providing one or more solutions to the needs by the user. The solutions are judged by the user or other users to generate the credits for a user offering solutions or sharing the solutions to the input needs.

In a step according to the present invention, the third sub-module is configured to collect one or more data of the user accounts contributing to a bid by a third sub-module. In another step, the third sub-module compute a selling price based on one or more data of the user accounts. In yet another step, the third sub-module is configured to receive the selling price of the user accounts determined by the user. The user is provided with an option to conduct bids, sell or buy user accounts for generating the credits to the user account.

In a step according to the present invention, the fourth sub-module is configured to learn and track one or more user behavior via a neural network. The user could generate the credits by sharing the behavior to other users in the system. In an embodiment, the first sub-module is a feed sub-module, the second sub-module is a need sub-module, the third sub-module is a bid sub-module, and the fourth sub-module is a lead sub-module.

Yet another aspect of the present disclosure is directed to a method for online social commercial network implemented with a web-server system via a network connection, the computer-implemented system having processor-executable instructions stored thereon that, when executed by at least one processor. The method comprises: (a) providing an access to one or more other users or organizations for the users in the network by a first sub-module; (b) providing an access to one or more partner websites selling products or providing services by the first sub-module; (c) providing a platform for the user to participate in promoting or marketing of one or more product or services by the first sub-module, wherein the user receives one or more credits based on the marketing of one or more product or services, (d) providing an option for inputting one or more needs by the user and creating a list of needs for the user by a second sub-module; (e) providing an option of sharing the need or keeping the need private by the user by the second sub-module; (f) providing a recommendation to one or more groups related to one or more shared needs by the second sub-module; (g) providing an option for setting up one or more pre-determined user preferences for the needs by the second sub-module; (h) filtering the recommendations based on the user preferences by the second sub-module; (i) providing an option for the users to join the groups providing one or more solutions to the needs by the second sub-module, wherein the solutions to the needs are judged by the user or other users to generate the credits for a user offering solutions or sharing the solutions to the input needs, (j) collecting one or more data of the user accounts contributing to a bid by a third sub-module; (k) computing a selling price based on the data of the user accounts by the third sub-module; (l) receiving the selling price of the user accounts determined by the user, wherein the user is provided with an option to sell or buy user accounts for generating the credits to the user by the third sub-module, and (m) learning and tracking one or more user behavior via a neural network by a fourth sub-module, wherein the behavior is stored in a database of the system, and the user generates the credits by sharing the behavior to other users. In one embodiment, the first sub-module is a feed sub-module, the second sub-module is a need sub-module, the third sub-module is a bid sub-module, and the fourth sub-module is a lead sub-module. In one embodiment, the present disclosure is directed to a method for implementing an online social commercial network.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1 illustrates a home webpage of an online social commercial network in a user interface or a system according to an embodiment.

FIG. 2A-2C shows a block diagram of the online social commercial network in a system according to an embodiment. FIG. 2A shows a first section of the block diagram of the online social commercial network in the system. FIG. 2B is a continuation of FIG. 2A and FIG. 2C is a continuation of FIG. 2B.

FIG. 3A-3D shows a method for online social commercial network in the system according to another embodiment. FIG. 3A shows a first section of the flowchart of method for online social commercial network in the system. FIG. 3B is a continuation of FIG. 3A and FIG. 3C is a continuation of FIG. 3B. FIG. 3D is a continuation of FIG. 3C.

FIG. 4 illustrates a first sign-up webpage encountered by the user in the user interface or system according to an exemplary embodiment.

FIG. 5 illustrates a home webpage encountered by the user upon signing up in the user interface or system according to an exemplary embodiment.

FIG. 6 illustrates a social media webpage in the user interface or system according to an exemplary embodiment.

FIG. 7 illustrates a profile webpage in the user interface or system according to an exemplary embodiment.

FIG. 8 illustrates a webpage reflecting the user's needs, sympathies, points, monies, etc. in the user interface or system according to an exemplary embodiment.

FIG. 9 illustrates a feature of building user community for the user in the system according to an exemplary embodiment.

FIG. 10 illustrates a feature of building user community for identifying user's motivation and needs in the system according to an exemplary embodiment.

FIG. 11 illustrates a system layout for building user community for the user in the system according to an exemplary embodiment.

FIG. 12 illustrates a dashboard with main attributes mapped to the user according to an exemplary embodiment.

FIG. 13 illustrates a need screen to be entered by the user according to an exemplary embodiment.

FIG. 14 illustrates a system response window appears after entering the user need screen according to an exemplary embodiment.

FIG. 15 illustrates a system response window with three proposed solutions to the user's need according to an exemplary embodiment.

FIG. 16 illustrates an example persona profile according to an exemplary embodiment.

FIG. 17 illustrates a matching solution towards the persona profile needs according to an exemplary embodiment.

FIG. 18 illustrates another example persona profile according to an exemplary embodiment.

FIG. 19 illustrates another matching solution towards the persona profile needs according to an exemplary embodiment.

### DETAILED DESCRIPTION

A description of embodiments of the present invention will now be given with reference to the figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention generally relates to a social networking system, and more particularly relates to a system and method for intelligent online social commercial network for providing solution to a user needs. The embodiments herein more particularly relates to a system and method using a social networking web portal facilitating the sharing of information between the users of similar needs for efficient transaction and analytics in the trading, and business. The disclosed system and method further motivates the users to address needs of other users by incorporating a reward module in the system.

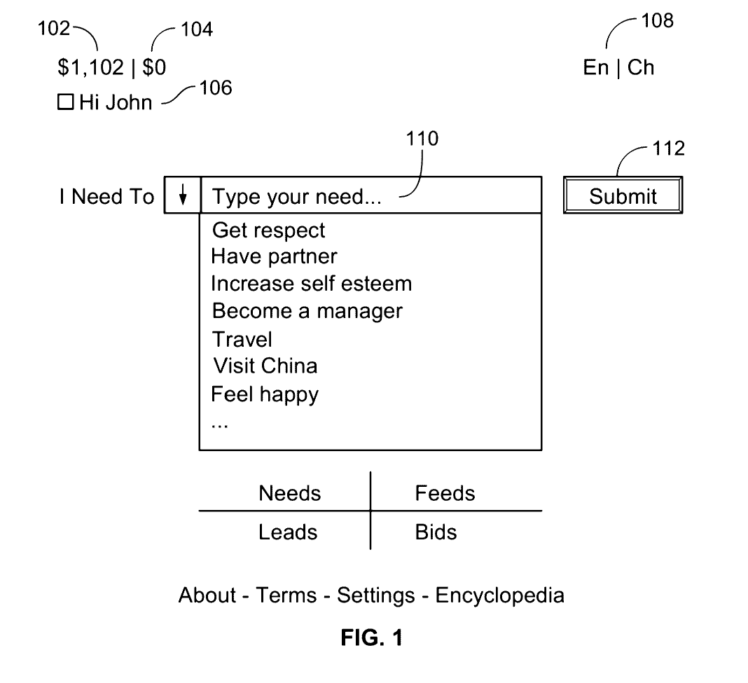

The present invention relates to a computer-implemented system for providing solution to a user with a social network or online social commercial network. FIG. 1 illustrates a home webpage of an online social commercial network in a user interface or a system according to an embodiment. When the user first accesses the system, the user is presented with a webpage, an example of which is shown in FIG. 1. The exemplary homepage depicted in FIG. 1 shows the credit on the user's account 102, accumulated real money 104, welcome username 106 and language selection 108. In addition, the webpage comprises a textbox 110 for entering a need and the submit button 112. The webpage shown in FIG. 1 has links to “Needs,” “Feeds,” “Leads,” and “Bids,” and at the bottom of the webpage, the standard footer links shown, such as “About”, “Terms”, “Setting”, and “Encyclopedia”.

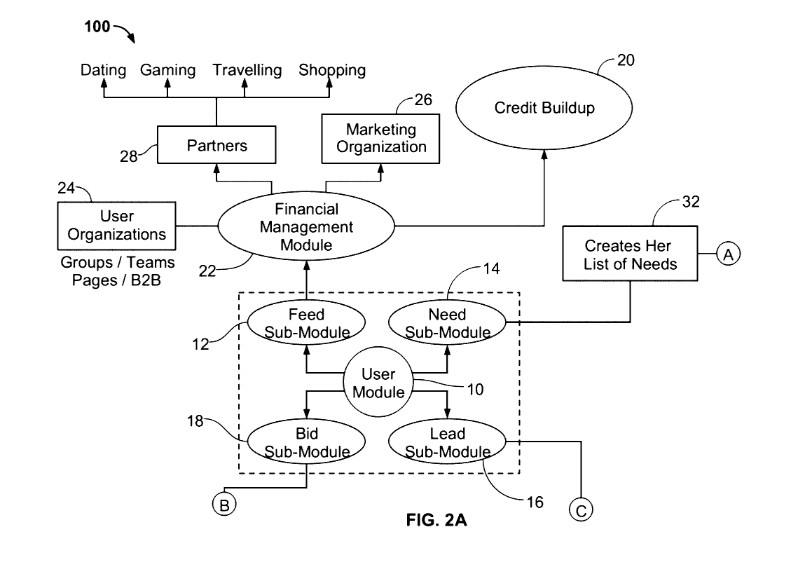

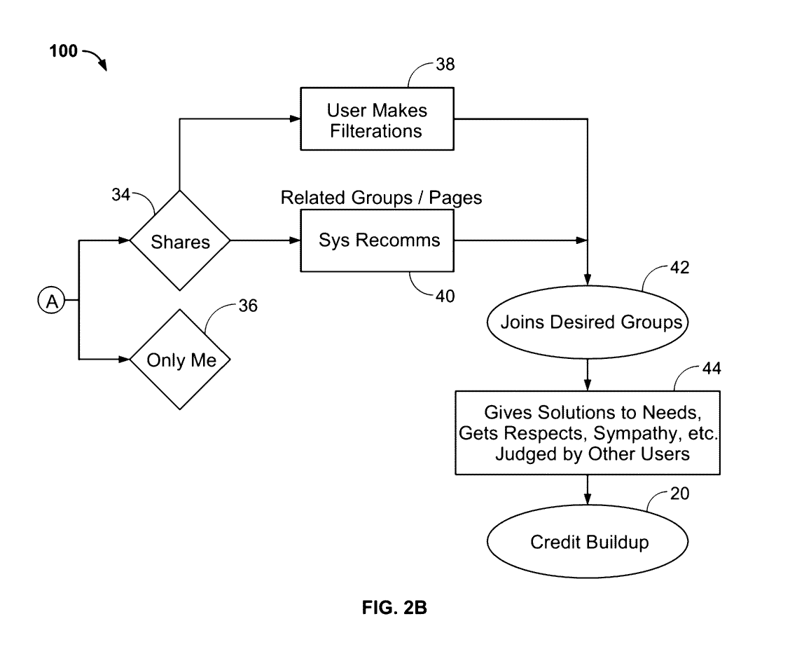

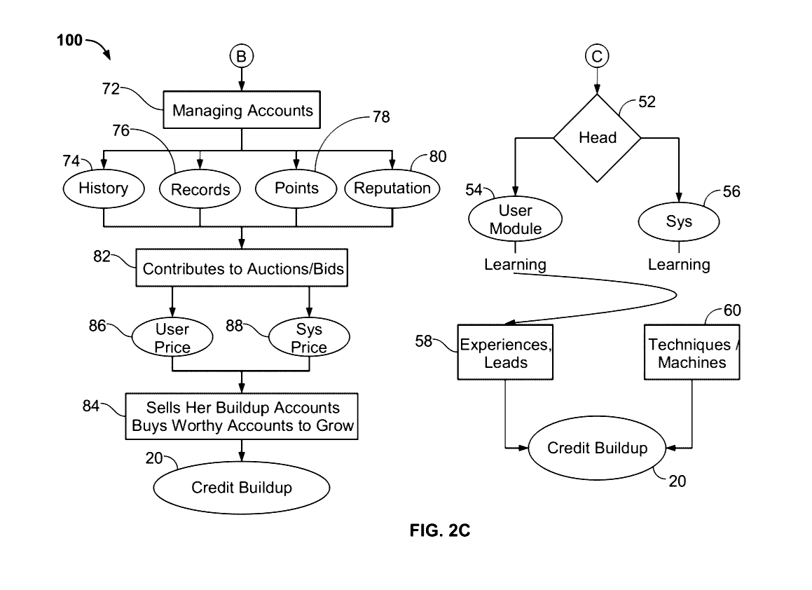

Referring to FIG. 2A-2C, the web-based online social commercial network is a computer-implemented system 100, which comprises processor-executable instructions. The said instructions executed by at least one processor, the computer-implemented system 100 comprises a user module 10, which includes a web server system via a network connection configured to control and monitor one or more sub-modules.

In one embodiment, the user module 10 comprises a feed sub-module 12, a need sub-module 14, a lead sub-module 16, and a bid sub-module 18. In an embodiment, the feed sub-module 12 is configured to provide access to one or more other users or organizations 24 through a financial management module 22.In one embodiment, the system 100 is configured to provide an option for the user to customize the feed sub-module 12 to a marketing organization 26. In one embodiment, the feed sub-module 12 is configured to provide access to one or more partner websites 28 selling products or providing services. In another embodiment, the feed sub-module 12 is configured to provide a platform for the user to participate in promoting or marketing of one or more product or services. The user receives one or more credits 20 based on the marketing of one or more product or services.

In an embodiment, the need sub-module 14 is configured to provide an option for inputting one or more needs by the user and creating a list 32 of needs for the user.

In an embodiment, the need sub-module 14 is configured to provide an option of sharing 34 the user need to other users in the network. In one embodiment, the need sub-module 14 is configured to provide an option of maintaining the user need privately or confidentially 36 with them. In one embodiment, the need sub-module 14 is configured to provide an option for setting up one or more pre-determined preferences on their specified need by the user. One or more recommendations could be filtered 38 based on the user preferences on the specified needs. In an embodiment, the need sub-module 14 is configured to provide recommendation 40 to one or more groups relevant to one or more shared needs of the user.

In one embodiment, the need sub-module 14 is configured to provide an option for joining the groups 42 providing one or more solutions to the needs by the user. The solutions to the needs are judged 44 by the user or other users to generate the credits 20 for a user offering solutions or sharing the solutions to the input needs. In an embodiment, the lead sub-module 16 comprises a neural network configured to learn and track one or more user behavior in the system. In one embodiment, the behavior is stored in a database of the system. In another embodiment, the user generates the credits 20 by sharing the behavior to the other users.

In an embodiment, the bid sub-module 18 comprises one or more user accounts 72 managed by the user is disclosed. In one embodiment, the bid sub-module 18 is configured to collect one or more data of the user accounts 72 contributing to a bid. In one embodiment, the bid sub-module 18 in the system 100 computes a selling price 88 of the user accounts based on the data of the user accounts. In another embodiment, the bid sub-module 18 is configured to receive the selling price 86 of the accounts determined by the user. The user is provided with an option to conduct bids, sell, or buy 84 the user accounts for generating the credits 20 to the user account.

In one embodiment, the credit 20 is one or more rewards comprising a gift or a reward point, or a gift voucher, or a cash reward, or one or more discounts. In an embodiment, the feed sub-module 12 is configured to provide access to the partner websites providing services including dating, traveling, shopping, or gaming 28. In one embodiment, the feed sub-module 12 is configured to provide an option for the users to create groups, pages, advertisements through a financial management module 22. In an embodiment, the system 100 receives a percentage of transaction, a percentage of profit or a fixed fee from one or more transaction made by the users in the feed module 12.

In an embodiment, the need sub-module 14 is configured to share 34 one or more internal web pages or external web pages in the server, or groups related to the needs that have been created and recommended by other users in connection with one or more similar input needs of the user. In one embodiment, the need sub-module 11 is configured to provide an option for the users to search one or more internal web pages or external web pages in the server, or groups related to the needs that have been created and recommended by other users in connection with similar input needs of the user. In an embodiment, the need may include one or more needs of physical, psychological, safety, or convenience.

In an embodiment, the bid sub-module 18 is configured to provide an option for the user to buy or sell the user account. In one embodiment, the bid sub-module 18 is configured to compute a selling price of the user account based on one or more data value including history 74, records 76, points 78, or credit reputations 80 in the user accounts. In another embodiment, the bid sub-module 18 is configured to provide an option for the other user to provide the data value to the user account.

In an embodiment, the user behavior is one or more methods or experiences of the user fulfilling the needs. In an embodiment, the lead sub-module 16 comprises an option for users to share one or more methods or experience of fulfilling the needs to other users by providing one or more comments, reviews, or reactions.

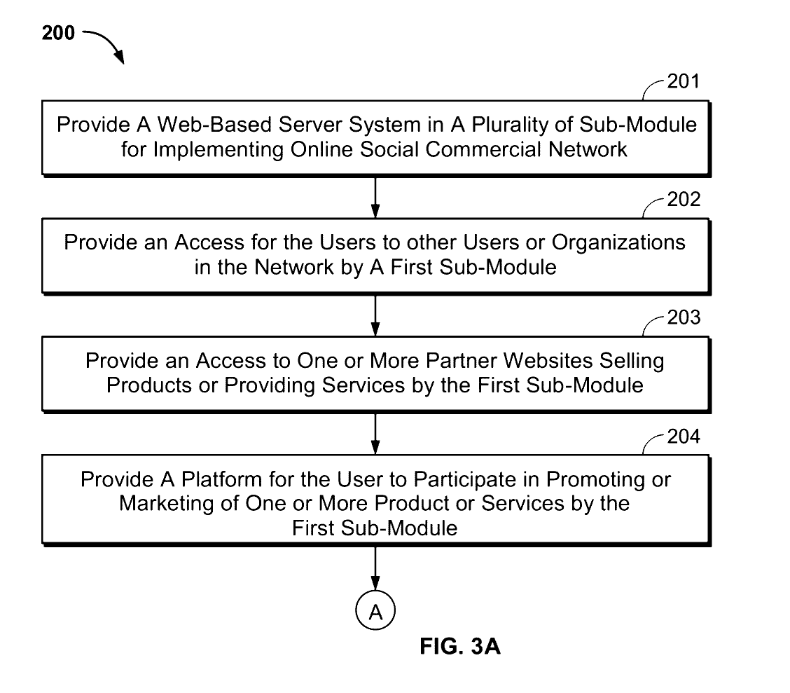

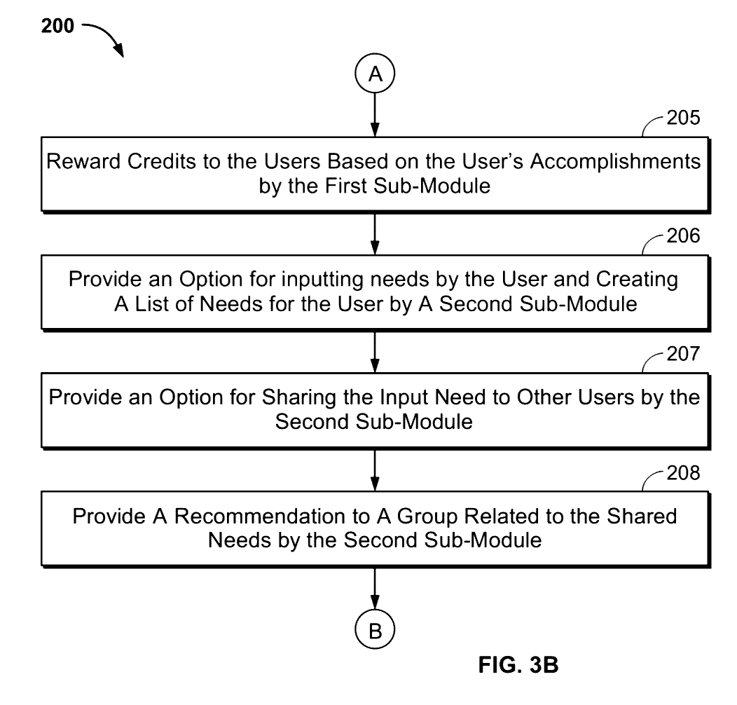

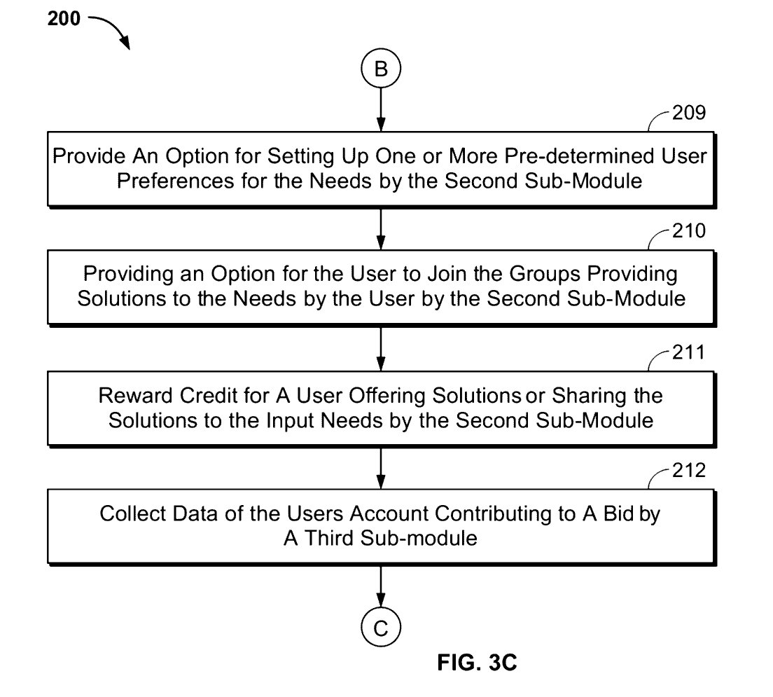

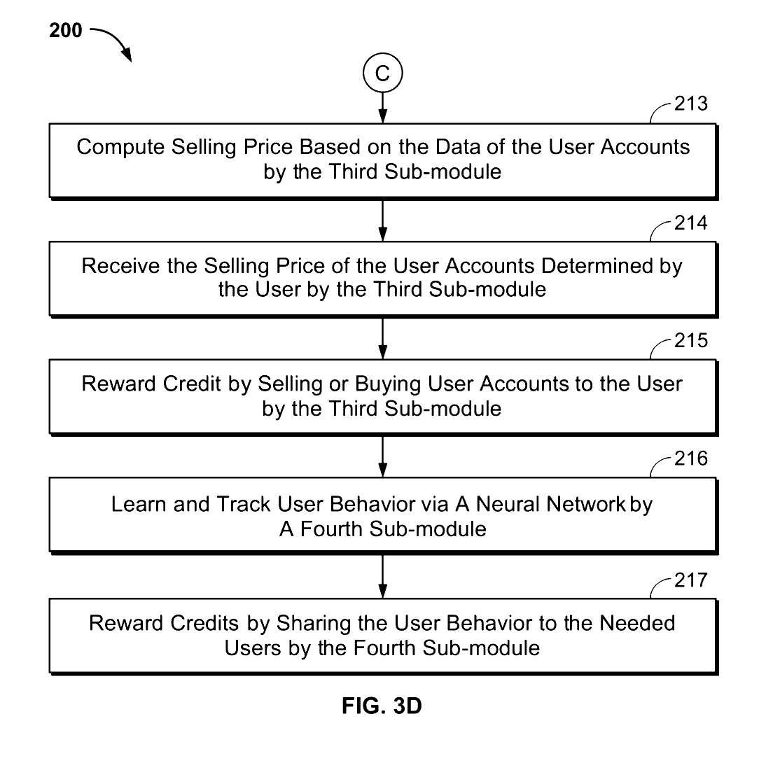

Referring to FIG. 3A-3D, a method 200 for online social commercial network implemented with a web-server system via a network connection is disclosed. In an embodiment, the method 200 comprises a computer-implemented system having processor-executable instructions stored thereon that, when executed by at least one processor to provide a plurality of steps using one or more sub-modules in step 201. In step 202, the first sub-module is configured to provide an access to one or more other users or organizations for the users. In step 203, the first sub-module is configured to provide an access to one or more partner websites selling products or providing services. In step 204, the first sub-module is configured to provide a platform for the user to participate in promoting or marketing of one or more product or services by the first sub-module. In step 205, the user receives one or more credits based on the marketing of one or more product or services in the first sub-module.

In step 206, the second sub-module provides an option for inputting one or more needs by the user and creating a list of needs for the user. In step 207, the second sub-module provides an option for sharing the need or keeping the need private by the user. In step 208, the second sub-module provides a recommendation to one or more groups related to the shared needs. In step 209, the second sub-module provides an option for setting up one or more pre-determined user preferences for the needs. In an embodiment, the recommendations could be filtered based on the user preferences on the specified needs. In step 210, the need sub-module is configured to provide an option for joining the groups providing one or more solutions to the needs by the user. In an embodiment, the solutions are judged by the user or other users to generate the credits for a user offering solutions or sharing the solutions to the input needs in step 211.

In step 212, the third sub-module is configured to collect one or more data of the user accounts contributing to a bid by a third sub-module. In step 213, the third sub-module compute a selling price based on one or more data of the user accounts. In step 214, the third sub-module is configured to receive the selling price of the user accounts determined by the user. In an embodiment, the user is provided with an option to conduct bids, sell or buy user accounts for generating the credits to the user account in step 215.

In a step 216, the fourth sub-module is configured to learn and track one or more user behavior via a neural network. In an embodiment, the user could generate the credits by sharing the behavior to other users in the system in step 217. Referring to FIG. 2A-2C and FIG. 3A-3D, the first sub-module is a feed sub-module, the second sub-module is a need sub-module, the third sub-module is a bid sub-module, and the fourth sub-module is a lead sub-module.

The present invention also relates to a computer-readable storage medium for providing solution to a user with a social network or online social commercial network. In an embodiment, a computer-readable storage medium having processor-executable instructions stored thereon that, when executed by at least one processors with a web-server system 100 via a network connection using one or more sub-modules. In an embodiment, the first sub-module is configured to provide an access to one or more other users or organizations for the users. In one embodiment, the first sub-module is configured to provide an access to one or more partner web sites selling products or providing services. In another embodiment, the first sub-module is configured to provide a platform for the user to participate in promoting or marketing of one or more product or services by the first sub-module. The user receives one or more credits based on the marketing of one or more product or services in the first sub-module.

In an embodiment according to the present invention, the second sub-module provide an option for inputting one or more needs by the user and creating a list of needs for the user. In one embodiment, the second sub-module provide an option for sharing the need or keeping the need private by the user. In another embodiment, the second sub-module provide a recommendation to one or more groups related to the shared needs. In another embodiment, the second sub-module provide an option for setting up one or more pre-determined user preferences for the needs. The recommendations could be filtered based on the user preferences on the specified needs. In another embodiment, the need sub-module is configured to provide an option for joining the groups providing one or more solutions to the needs by the user. The solutions are judged by the user or other users to generate the credits for a user offering solutions or sharing the solutions to the input needs.

In an embodiment according to the present invention, the third sub-module is configured to collect one or more data of the user accounts contributing to a bid by a third sub-module. In one embodiment, the third sub-module compute a selling price based on one or more data of the user accounts. In another embodiment, the third sub-module is configured to receive the selling price of the user accounts determined by the user. The user is provided with an option to conduct bids, sell or buy user accounts for generating the credits to the user account. In an embodiment according to the present invention, the fourth sub-module is configured to learn and track one or more user behavior via a neural network. The user could generate the credits by sharing the behavior to other users in the system 100.

In an embodiment, a need could be any human problem or desire, such as basic human needs or complex problems facing large organizations. Various needs are contemplated, which include physical needs (accommodations, food, transportation, etc.), psychological needs (sympathy, confidence, self-esteem, buddies, mentoring, relationship, etc.), safety (physical security, health, etc.), convenience (chores, tasks, etc.), and various other needs.

The user interface can run on various devices and environments, such as mobile devices, web interface, dedicated applications, etc. The system 100 could work in multiple countries and in multiple languages. There are no barriers in the system 100 and essentially any person can participate in the system 100 and earn money. The system 100 facilitates multiple ways of earning money for the user. One way is by earning teams, pages, team works and groups. By using the system 100, users get points and build up credits based on the points they have collected. For example, users may get points by defining real projects (B2B, C2C, etc.).

Users and businesses can also earn points by marketing their own goods, products, services or by marketing for companies as agents, affiliates, marketers, etc. Users can also accumulate points or credit by organizing other users. One way of doing so is by giving solutions fulfilling other persons' needs and building up credits due to the votes. Another way of building up credit is by creating organizations, such as multi-level marketing (MLM) organizations, etc. Yet another way to earn income in the system 100 is by developing reputable accounts and participating in auctions to sell such accounts.

In some embodiments, the system 100 itself also generates income. One way of generating income is contributing to real projects, by using the knowledge built through solving users' needs. Another way is by charging commissions on the bids for the user accounts auctions and sales. Yet another way is to charge fees or transaction commissions on partner. It is also possible to generate income through advertising on the system 100.

The system 100 provides intuitive and simple space where they could earn money and address their needs. The users can easily manage projects in the fields they do not have full proficiency without attending classes or seminars. With the use of the system 100, users are able to recognize and address the needs, which in the past were obstacles to their progress for a given project, task, or endeavor. Additional advantages of the system 100 for the users is the ability to learn how to solve problems, provide solutions, handle their needs, and also manage projects all while earning money and enjoying the process. As discussed above, users can also earn money directly (through the sale of accounts) and indirectly (through marketing organizations, commissions, and rebates from the partner companies) by using the system 100. The earning potential of the users is not limited and in some cases can even exceed the earnings of the system owners and operators. Furthermore, the system 100 uses developing personas feature to identify the interest and requirement of the users. The system 100 further provides a feature to the user for building the user community to build credits

The invention is further explained in the following examples, which however, are not to be construed to limit the scope of the invention.

### EXAMPLES

### Example 1

FIG. 2A-2C is a diagram of one example of the system 100, through a number of possible interfaces, user module 10 can access several aspects of the system 100. When the use first accesses the system 100, she is presented with a page an example of which is shown in FIG. 1. The exemplary homepage depicted in FIG. 1 shows the credit on the user's account 102, the accumulated real money 104, and the language selection 108. In addition, the webpage contains the textbox for entering a need 110 and the submit button 112. The webpage shown in FIG. 1 has links to “Needs,” “Feeds,” “Leads,” and “Bids,” described. In addition, at the bottom of the webpage, the stander footer links shown, such as About, Terms, Setting, and Encyclo.

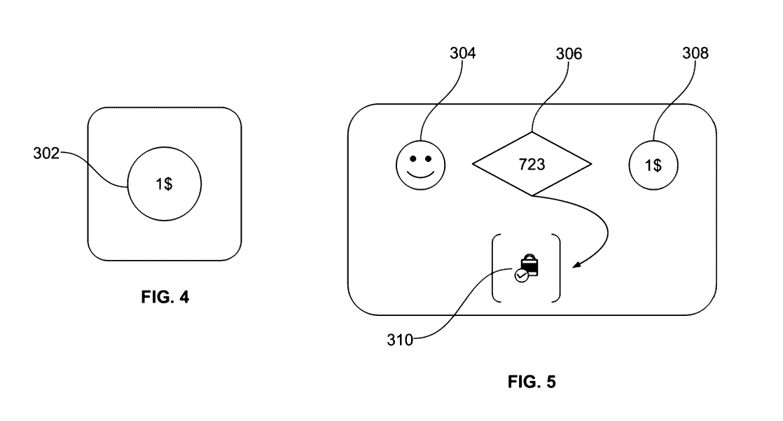

In one instance, the system 100 uses a simplified interface. Further, no login or signup screens exist; user clicks on logo and gets a number and her credit of $1 or a similar value in a different currency. The first page encountered by the user, the registration page, is show in FIG. 4. By clicking on “$1” 302, the user receives his first credit of $1 and is presented with the next page, the home page, shown in FIG. 5. Preferably, on these two pages there are no words and the user sees only numbers, colors, icons, shapes and/or signs. As mentioned above, the “$” may be different for different localities. The user's identification consists of three sets of numbers (referred to as “number,” “class,” and “grade”) each between 0 and 999. For an exemplary user, the numbers may be 723 in class 89 and in grade 56.

This method of number allocation allows for 1 billion users. The range of possible numbers, classes, and/or grades might be increased to allow for more users. The values may be allocated to users randomly, or following a predefined a predefined method. In the above example, the user's identification is represented as follows:
(723)
   <89>
      *56*

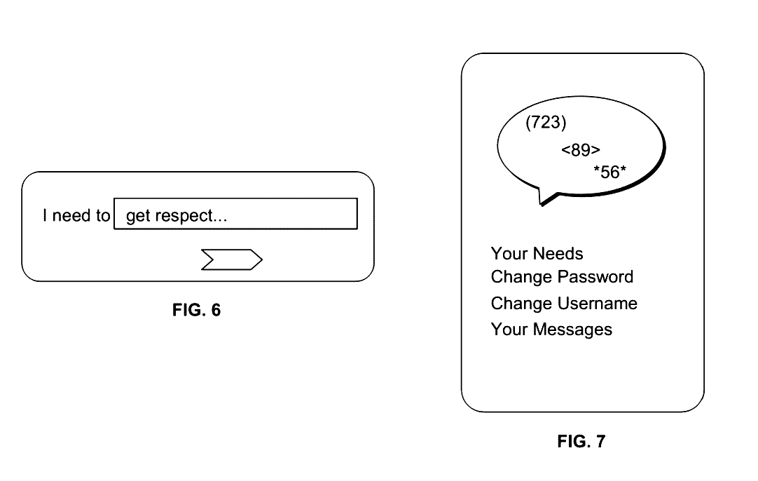

At the home page show in FIG. 5, the user may click on image 310, which takes the user to the page where he can enter his username and password. The user may change use username only one, but in other instance, the number of permitted changes may be different. At the home page, the user can also click on image 304, which brings the user to a social media page shown in FIG. 6. On this page, anytime the user submits a need, that need is registered on his needs part in his profile. The system 100 sends the needs to other users. The factors in selecting the users to the profile are (1) the submission of similar need in the past (2) location, (3) language, (4) profile information, and other metrics. Initially, the user does not have buddies, but as he uses the system 100 further and acquires buddies a page with buddies would be accessible to the user.

When the user clicks on images 306 bearing his number on the page shown in FIG. 5, he is taken to the page shown in FIG. 7. This profile page has links to the pages or pop-up windows that enable the user to see his needs, change the username, change the password, and manage his messages.

### Example 2

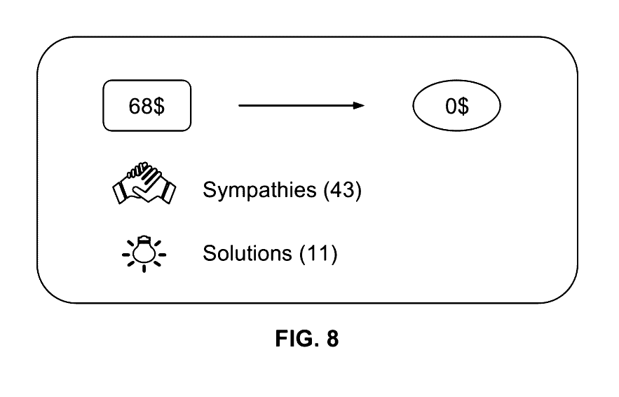

Icon 308 in FIG. 5 may be different depending on the number of credit points acquired by the user in the system 100. As explained elsewhere in this disclosure, the number of points increases depending on the user's activity. In addition, the system may add points to the user's account every predetermined period, such as a day, week, month, etc. When the user clicks on image 308 bearing the number of points he has on the system 100 shown in FIG. 5, he is taken to the page shown in FIG. 8. In the page shown in FIG. 8, the user can monitor the earning of the points and the conversions to real money, track sympathies received by other users, and view the solutions to this need(s). The assignment of points occurs according to the following exemplary algorithm:
1 Login=$1 (One time 1 24 hours)
1 Need=$1
1 Sympathy=$1
1 Solution=$1

The exemplary algorithm may be change to any other point allocation system depending on the value assigned to a given action and a variety of other factors, such as frequency of logins, uniqueness of the needs, etc. One aspect of the present disclosure is a method of providing information related to one or more needs. The method comprises acquiring a description of the need from a first user having an account; offering the first user one or more resources with information concerning satisfying the need; and sharing the description of the need and the one or more resources with a second user. The method further comprises accepting feedback from the second user concerning the need of the first user; and modifying a value of the account of the first user based on the feedback of the second user. The one or more resources may be based on the information provided by a third user.

The method may further comprise accepting feedback from the first user concerning the one or more resources and modifying a value of an account of the third user based on the feedback from the first user. The method may further comprise accepting feedback from the second user concerning the one or more resources and modifying a value of an account of the third user based on the feedback from the first user. The method may further comprise suggesting to the first user an entity capable of fulfilling the need of the first user. In one example, the method may further comprise providing a discount on the goods or services that fulfill the need of the first user purchased through the suggested entity. The method may further comprise of facilitating a sale of the account of the first user.

### Example 3

Before the user can take advantage of the system 100, she needs to register on the system 100. When the user submits her first need, in the text box of needs shown in FIG. 1, she receives her registration number. The user then can add the username and could complete or edit her profile later. User may register many accounts, and any one account is approved by unique personal identification for cash withdrawals. Registering multiple accounts is useful for selling them (in the bids portion of the system 100), if the user manages them to obtain reputation and credit. There is also competition for registration in the system 100 on the web or through an application as any account has a number, which could be counted for reputation or associated with another value metric. The user's first need appears in the table of needs and the user can specify priority and statement for it. By clicking on the “needs” link on the Home Page shown in FIG. 1, a user is taken to the “needs” section 14 of the system 100, by loading a page with the user's table of her needs. The table may be relatively simple and every registered need is reflected in this page. The needs have a priority, statement, related groups and pages, and involved users.

Every part of the table are clickable and give users the ability to add additional details for a given need. The system 100 suggests the groups and pages related to the new and old registered needs. These suggestions may be customized by the user through the configuration of her profile or in some other manner. The following table is an example of the needs table.

| | | | | Involved |
|---|---|---|---|---|
| No | Brief Description | Statement | Groups-Pages | Users |
| 1 | I need to feel | Progressing . . . | Happy Teenagers | king2020 |
| | happy. | | (List) | (List) |
| 2 | I need to have | Fulfilled! | Our Dating (List) | Hero |
| | partner. | | | (List) |
| 3 | I need to learn | Researching . . . | Deutsch Lernen | @tiger |
| | German. | | (List) | (List) |
| . . . | . . . | . . . | . . . | . . . |

### Example 4

Referring to FIG. 2, user inputs one or more needs in need sub-module 14. In block 32, the system 100 creates a list of needs for the user. The user has an option of sharing some of her needs in block 34, or keeps the needs private in block 36. For the shared needs, in block 40, the system 100 provides recommendations to the groups related to the one or more shared needs or pages, where similar needs have been addressed. The software checks the internal (and some external) pages in, such as for example Facebook, and groups related to the needs that have been created and recommends by users in connection with similar needs.

By clicking, the user visits to these pages directly and can start to act there. The user may set up a number of pre-determined preferences. In block 38, based on the user's preconfigured preferences, the recommendations provided in block 40 are filtered. The user could accept the pages or groups, which the system 100 recommends, or she does not have to accept them. In addition, she could customize the types of pages she wants to be recommended by topic, size, relation, etc. The user can search the groups and save them in the table of needs, in connection with the related need. In block 42, the user joins the desired groups. The groups, to which the user joined in block 42, provide solutions to needs; facilitate respect, sympathy, etc. In addition, the solutions to needs provided are judged by other users in step 44. This leads to the credit buildup in block 20.

At every page or group, the user could provide a solution to others' needs and receive confirmations that show that other users accept her solution. In addition, she could get respect for what she writes or shares as a need. Accordingly, a higher level of activity in more groups or pages generates more opportunities to earn money. Suggesting solutions to fulfil the users' needs is an intended trend of the system 100. It may take some time before the system 100 accumulates sufficient data to offer the solutions. Initially other users may propose different and not necessarily optimal solutions. In time, however, through users' confirming the best solutions to their needs, the system 100 may score such solutions and develop the database of high quality solutions offered to the users. Likewise, the system 100 allows fresh solutions to be offered. The users get respect for offering a solution or even for sharing a solution offered by someone else.

Users enter about their own needs (problem, request, and sympathy) or share them in social pages and receive solutions. All the users may vote as to whether a given solution adequately fulfils the need of the user. The user herself confirms whether one or more of the solutions have fulfilled her need. The votes and confirmation are reflected in the generation of points or credits to people who offered the particular solution. An exemplary award of points may be as follows:

Any share of your need by others=1¢

Any share of your need by yourself=10¢

Any solutions you suggest and is confirmed by others=1¢

Any Solution you suggest and is confirmed by the person with the need=10¢

All users can provide sympathy to the user with the need and all users can participate in judging the quality of the solution. Such an arrangement, while simple, attributes different weight to the opinions of the uses with the need being addressed and other users. Various techniques of awarding points are contemplated. An important feature of the system 100 is that the users pay nothing or zero investment. The users have the ability to earn money. The system 100 is funded by partners, advertising or other means discussed above.

### Example 5

Users also can use feeds 12 of various persons, groups, etc. in the system 100 to fulfil needs. By clicking on Groups-Pages or Involved Users, the user goes to respective pages of feeds. Referring to FIG. 1, the user can access the feeds section of the system 100 by clicking on the “feeds” link. When the user access the feeds, by clicking on the “feeds” link, she is presented with another page. This page shows the posts of user's buddies, the posts of groups which user has selected as related ones to her needs, etc. The system 100 also provides new suggestions for new groups and methods of fulfilling needs, by reading keywords, checking team works, etc. In addition, the system 100 may match users based on the similarity of their needs, their selected pages, their location and their routes, respectively and may offer them to be linked together.

Feeds provide the user the ability to build up credit and earn or save real money. As one example of how a user may earn money, the user can have her contents shared, earn sympathy, or earn respect, which can be equivalent to 1¢. for example. A solution to a problem, being involved in teamwork may be worth 10¢. Uni-level organization is worth $1, and binary MLM is worth $10. There are certain thresholds when the users can “cash in” their points. These thresholds can be set to any arbitrary number and in some instances may be different for different users. For example, these thresholds may be 1K, 10K, 100K, 1M, 10M, 100M, 1 B, 10 B, or 100 B. Getting respect (from other users), giving solutions (confirmed by other users) and creating new groups, pages or team works (depended on the level of activity), builds up credit for the user.

The user may customize the feed section of the system 100 in a variety of ways. As part of the feeds, the user can invite other people who are open to this program to create her organization as a part of the Multi-Level Marketing (MLM) or Uni-Level Marketing. As examples, under the Uni-Level Marketing, the user adds $1 to her credit by each 1-1 balance and 10¢ for each accepted invitation in genealogy without any balance (Uni-Level). Under MLM, the user earns credits because of predetermined rules. For example, the user may earn $1 for level 1 buddies, for participants in level 2 positions, the user may earn 0.5¢, for participants in level 3 positions, the user may earn 0.25¢, etc. The user also has the flexibility to manage her marketing organization, while in some other instances; the system 100 manages the user's marketing organization in accordance with predetermined rules.

Block 22, financial management module, is a module that handles all points and money related transactions to the user accounts. In some instances, financial management module is a part of software that manages all the money-related aspects for users and does money management for the users. Connections with partners 28 are accomplished through financial management module block 22. A wide variety of partners is contemplated. Preferably, partners may be websites that sell products or provide services, such as dating, traveling, shopping, gaming, etc. An optional feature related to financial management module is binary MLM, block 26, where the user can participate in direct marketing of the partner's products or services. The feeds section provides access to various users and organizations 24. These are the groups, pages and teamwork instances created by the users.

### Example 6

Preferably, the system 100 has business partners 28. The user can do shopping, gaming, travelling, dating and can use the service providers by the partner companies using her credit accrued in the system 100 and build up new credits due to each partners' conditions. For example, when user spends $10,000 in one of our gaming partners' websites, or $5,000 at one of the online shopping partners, she may receive some credits in the system 100. When the user uses the partners in this way, $100 in credit can give her $1 in real money and when the partner transactions actually occur, she adds 1% to her balance. In the above example, the user adds 1% of the amount spend on the partner companies' websites, in other words 1% of $10K plus 1% of $5K, for the total of $150 , to be added to her balance in the system 100. As part of the transaction, the system 100 also receives a certain percentage of the transaction total, percentage of profit, or a fixed fee from the transaction. For example, depending on the arrangement with the partner company, the use of the system 100 may receive $100 from the above transactions.

The increased traffic to the partners is an incentive to become one of the present system's partners. Moreover, the users in the system 100 may produce additional new needs related to the partners' products and services. For example, users and marketers can advertise the system's partners through the system media. Then, the partners can advertise through the system free or by taking advantage of discounts. After the user builds up her credit, she can spend it on fulfilling her own needs. The user can shop, travel, play games, date, etc. In some instances, it may not be necessary to exchange the credit for money. Preferably, these activities are done through the partner companies and websites 28 (e.g. through amazon or through match.com or such partners). In some instances, the partner website accepts the points and credits. In some instances, the partners provide a discount to the users, which discount may depend on the user's accomplishments.

In the bids section 18, users can also bid on accounts and because of such bids; they can buy and sell accounts. Users may open many accounts on the system 100. They could collect points, get credits and reputation and then contribute in auctions held by the system 100. User accounts have records, history, points, reputation and in some instances some other metrics. These four factors contribute to the value of the account. Any user can grow some accounts to sell in auctions in the future.

Users can manage their accounts in block 72. The managing-account block is a simple back office, in which the user can manage her accounts. Specifically, the user could participate in auctions through any of her accounts, specifying her own price and ask others to offer their prices. The user can view her history in block 74, records in block 76, points in block 78, and credits in block 80. This information aggregated in connection with each user account adds value to it and earns it more desirable when the account is offered up for sale in block 82.

### Example 7

Accounts that are opened earlier, have more worth and there is competition to open accounts. Accordingly, the timing of the account opening is important and an earlier-opened account is more valuable than a later-opened one with other associated metrics being equal. In addition, other users provide reputation to accounts by judging the activities and the user is collecting points and credits by suggesting solutions or receiving reputations and sympathies.

The system 100 computes a suggested price in block 88 based on the history, records, points, and credits information. The user can independently determine the value of her account by comparing it to the sales numbers of comparable sold accounts. In block 84, the user can sell her account to another user. The user can also buy another account to build up its characteristics, such as history, records, points, and credits to sell it in the future. This also results in credit buildup in block 20.

In the leads section 16, head 52 classifies and catalogues the user's leads. The head is the name of the board, which is the manager of the learning organization. Based on the system recommendations, users explore the leads to fulfill their needs, thereby building up credit. The system 100 provides a dedicated space for users to describe their method of fulfilling the needs, provide overviews. User can use the list of needs and the pre-registered related groups created by other users as the encyclopedia of needs, every time, everywhere on the system 100.

Learning occurs based on users' experiences in the paths to fulfilling their needs. Users are sharing and commenting on solutions and the system 100 classifies these experiences in proposals to be shown to users in the encyclopedia of ways of fulfilling various needs. The learning part that relies on the software and artificial intelligence to aggregate the needs and the experts who draw from the same information to create solutions to the needs and classify them.

The broken arrow between users 45 and learning system 56 signifies that learning in both parts works based on what users share for learning and they have no different trends. In some instances, the head is the combination of software and experts supervising what users 54 do in the organization. The cataloguing of leads occurs continuously. Users visit various social media pages and web pages and comment on their experience of fulfilling their need. Learning system 56 has a number of experts as well as artificial intelligence algorithms.

The user visits, comments, reviews, or otherwise reacts to the resources that addresses the user's needs in block 58. Other users may also rate the user's experience. The experts and the algorithms in block 60 use these two sets of information to catalog leads and needs and to build up the user's credit in block 20. Users build up credit in the leads section by connection to the social media pages. Users share as their experiences gets respect, and is used to aggregate in the encyclopedia. By accomplishing these results, users build credit.

This learning system 56 is also a part of the media. There is an option for the users for sharing in learning system 56, which could be shared in any pages. If system 100 uses users' models or experiences for its library, they are again given points. The machine is preferably the software that connects and serves many functions, but primarily connects the social media pages to needs' management area. In the context of the learning system 56, machines in block 60 receive comments from the system software to specify and classify what works for the library. The information in the library is aggregated in the encyclopedia for future use.

### Example 8

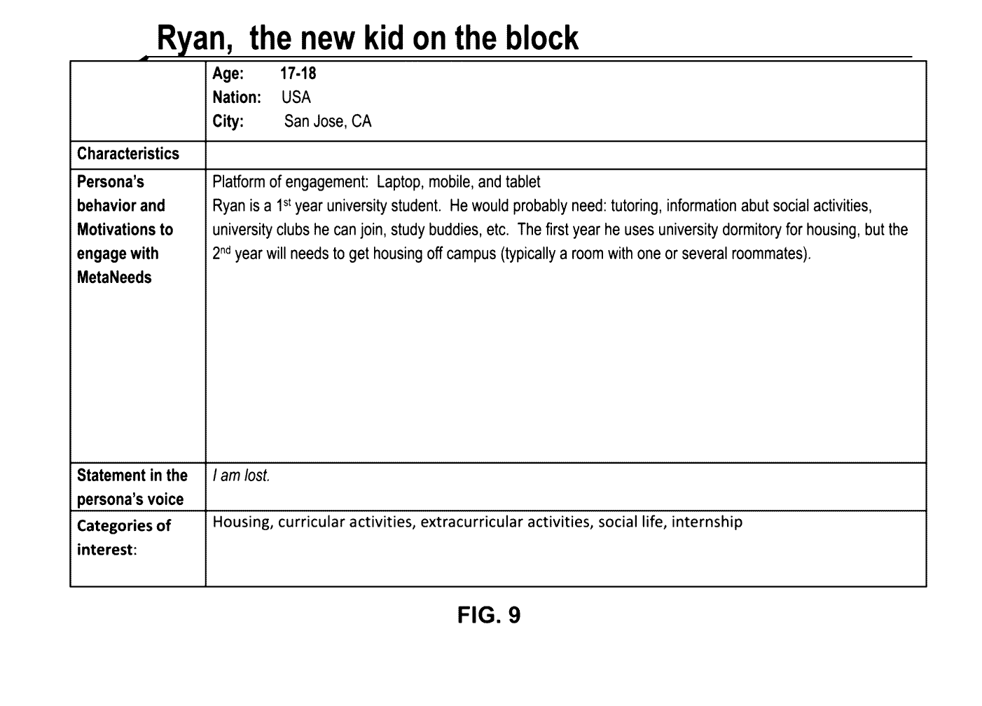

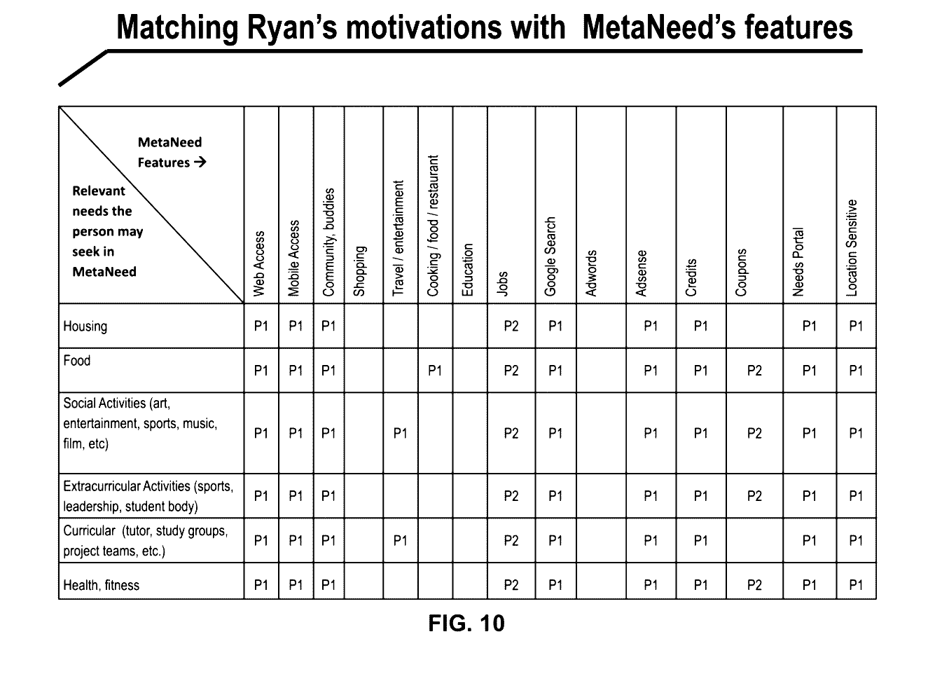

Referring to FIG. 9 and FIG. 10, the system 100 further provides a feature of building the user community to the user in earning or building credits, which is illustrated with new kid, Ryan on the block in need and his solutions. For an example, the credits of hierarchy are as follows:

Login—$1 (limit to once per 24 hours)

Entering a need—$1

Adding Buddies—$1

Proposing a solution—$2

Proposing a solution that is accepted—$10

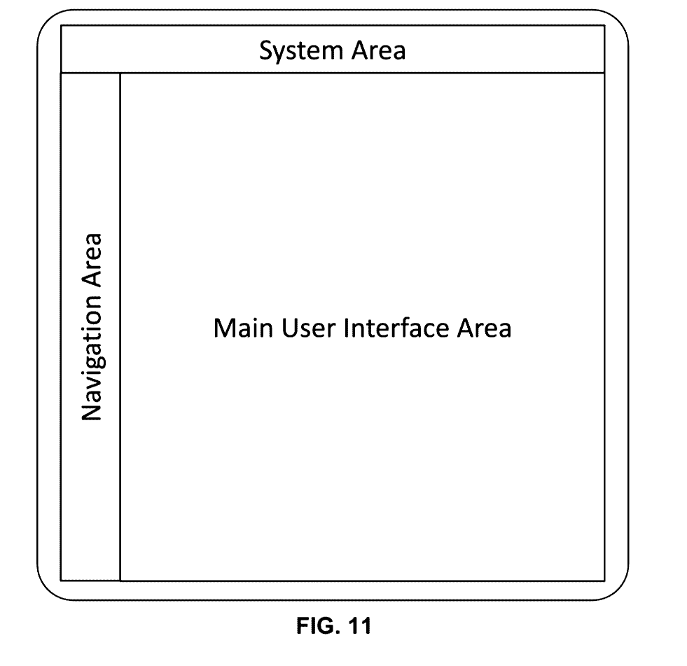

Referring to FIG.11, the system layout was included with a system area, a main user interface area and a navigation area. The system area include login, profile, settings, buddies, credit, notifications, search, application navigation such as new need, dashboard, account, sync, etc. The main user interface area includes dashboard, app interactions such as adding need, reviewing responses, rating responses, sharing/proposing needs, inviting “buddies”, and community or buddy lists. The navigation area includes dashboard navigation and needs section.

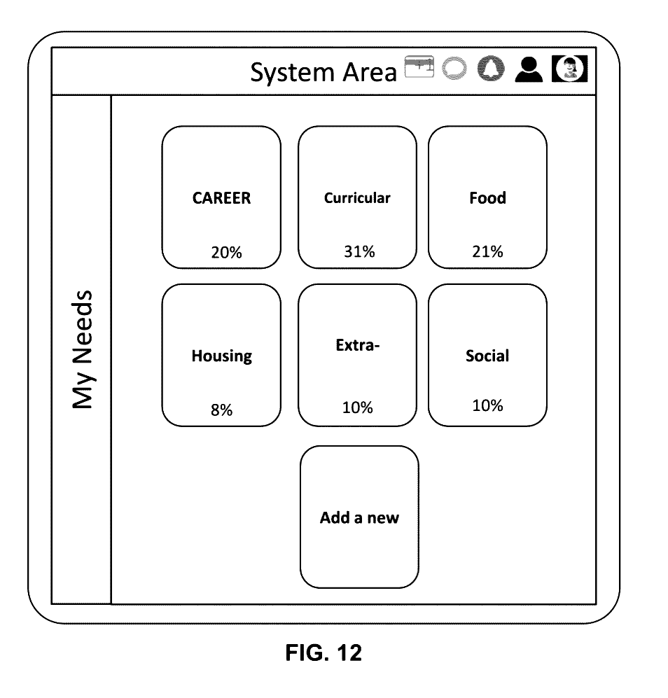

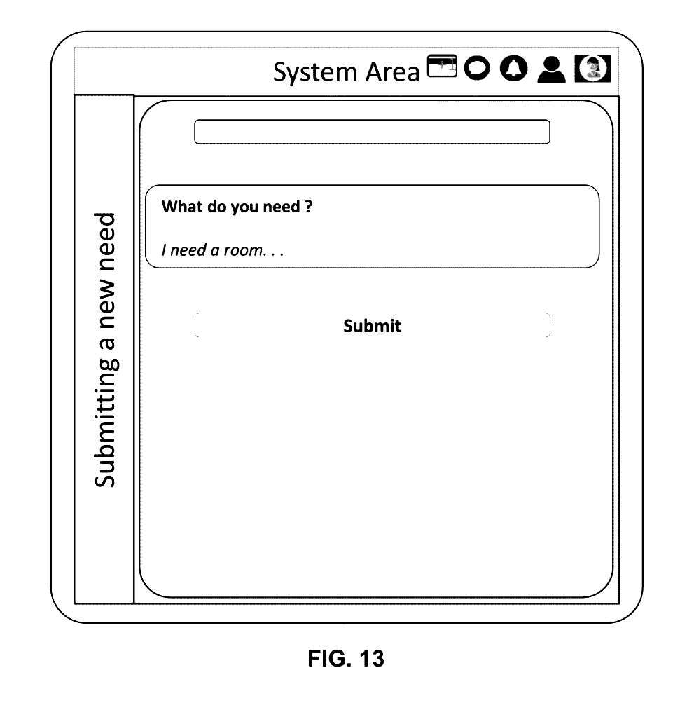

In an instance, the dashboard could include six main attributes mapped to the persona as shown in FIG. 12. After login “+1” is added on the credit icon (once per 24 hours). The user can login with their other social networking accounts. Initially, percentages will not be displayed, as user enters needs, percentages are shown to provide a relative view. In FIG. 13, a new need could be submitted by simply typing the need and clicking on “submit” icon in the main interface area. Every new need is automatically categorized based on the given keywords entered by the user.

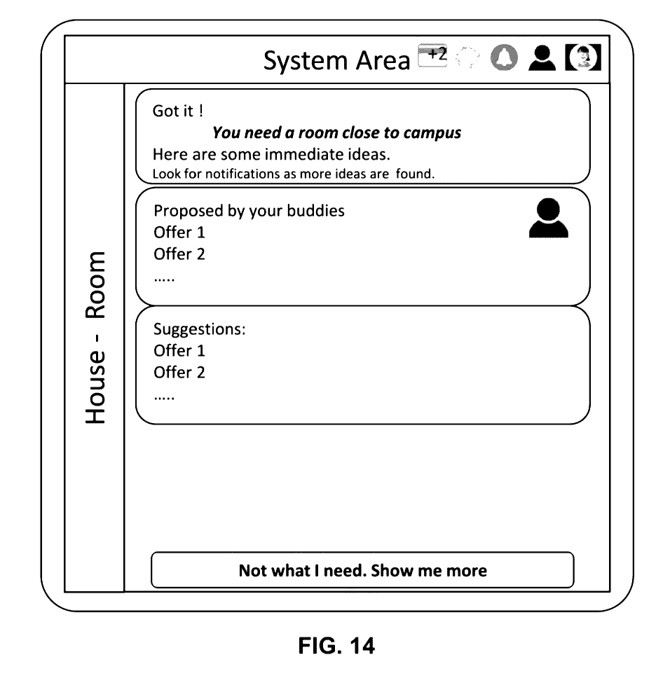

Referring to FIG. 14, in another instance, the system is configured to respond immediately with three proposed solutions in each category, and the system could suggest from other web search results.

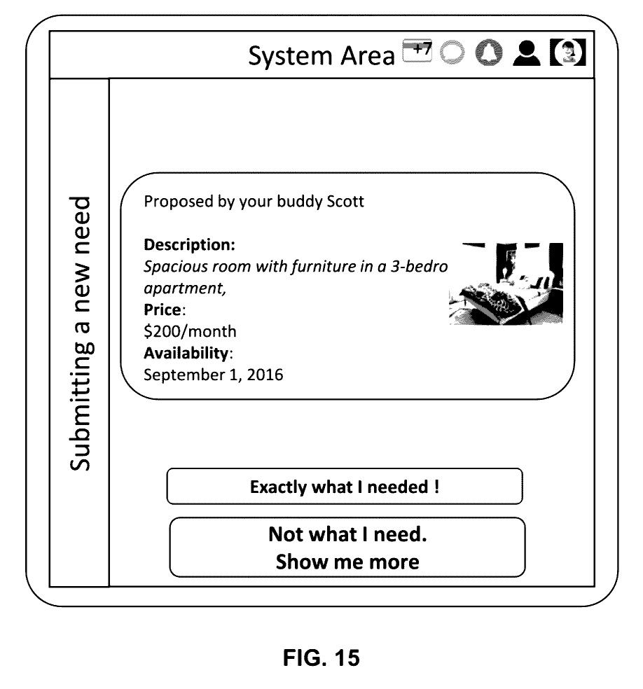

The credit information is shown on the credit icon. Referring to FIG. 15, the system responds immediately for the entered need by a user with three proposed solutions. The system will propose the additional solutions and notify the user based on their availability. Clicking on each solution provides additional information associated with the solution.

By clicking on “Exactly what I needed!” Ryan accumulates credit (+5), Scott accumulated credit (+10). By clicking on “Not what I need, Show me more”, user is presented with the next available solution. Once all three available solutions are exhausted, user could look for new solutions by checking the notifications regarding the same solutions, from other users in the system.

In another instance, the system 100 for an intelligent online social commercial network also comprises a feature for developing personas, generating definitions, list of identified personas, and personas descriptions. The personas could be developed by including personas real names, calling out personas key behavior and motivations, including basic demographic information, provide a statement in the persona's voice, and what keeps the persona up at night. Calling out personas key behavior and motivations is done to build a valuable value proposition it is necessary to understand why people would agree with that value proposition, and how they would go or focus about it. The demographic information is included to understand the persona. The statement might be something heard in a research interview, or it might be a fabrication, which is the beginning of the customer personality.

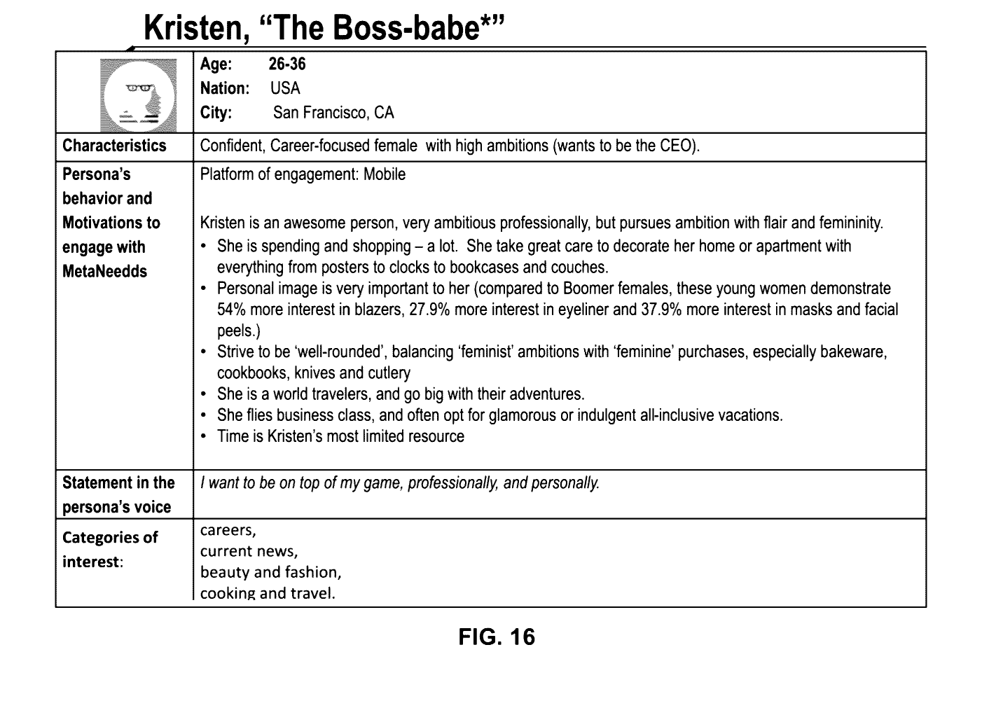

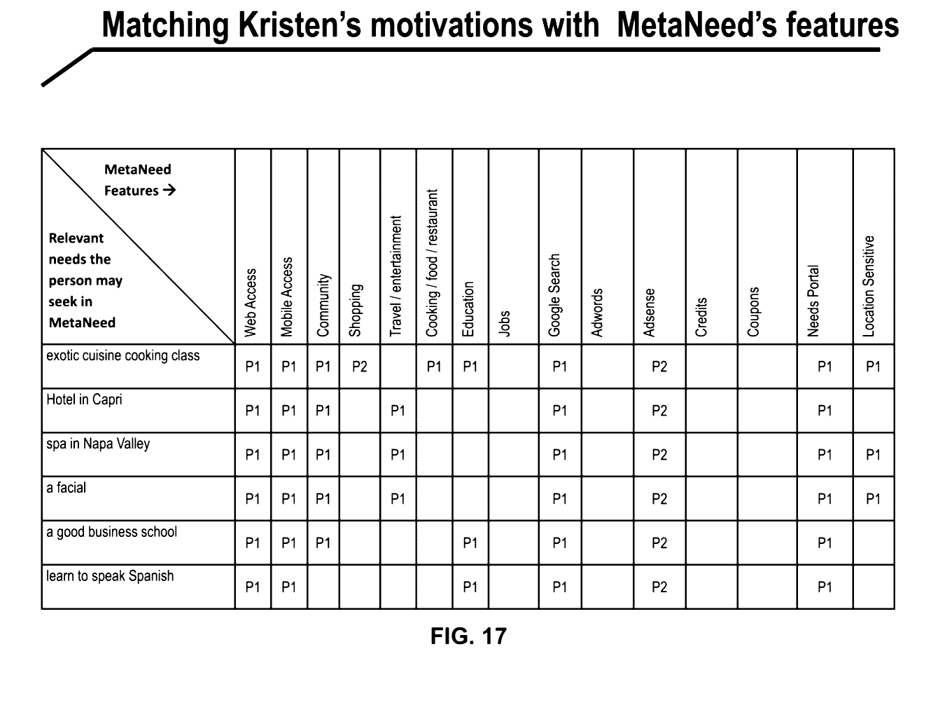

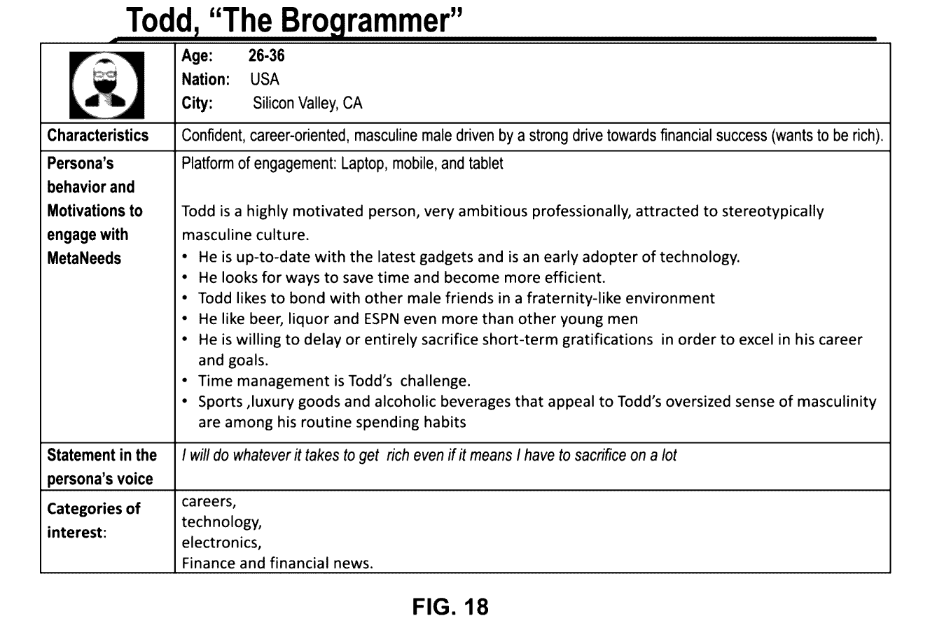

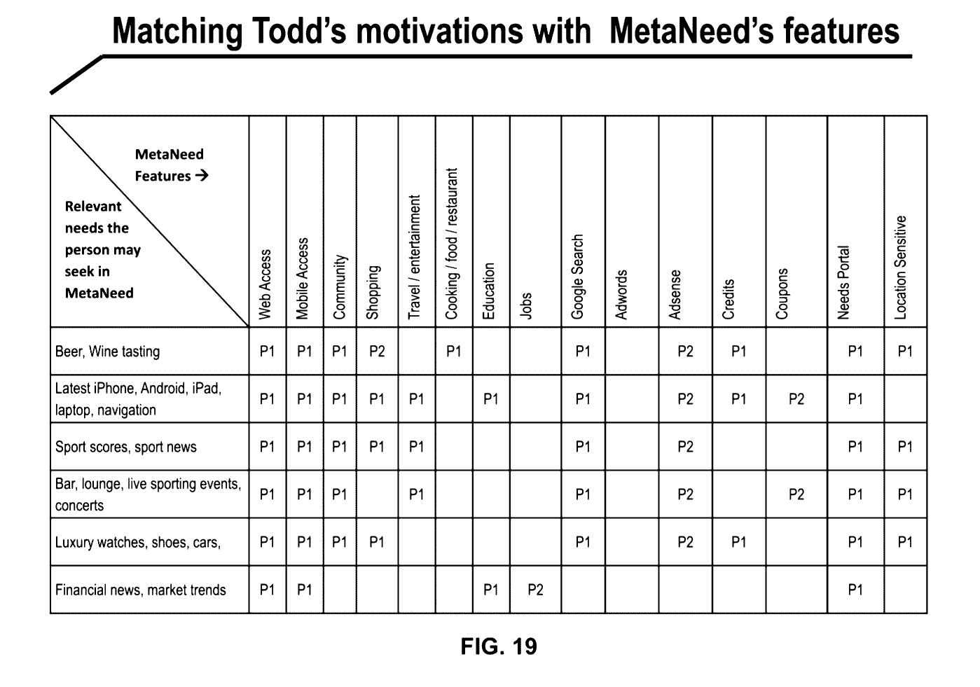

Some of the examples of the millennials personas are Kristen, “The Boss-babe”, Todd, “The Borgrammer”, Joe, “The underemployed”, Jack, “Shoutout”, Steve, “Nostalgic”, Mary, “Travel Enthusiast”, Julie, “Culinary Explorer”, Vicky, “Exhuberant”, Mike, “The Collector”, Eric, “The Quarter-Life Crisis”, Crystal, “Millennial Martha”, Amanda, “Millennial Mom”, etc. Referring to FIG. 16, an example of the millennials personas Kristen, “The Boss-babe” profile, matching the motivations towards the different needs featured in the present system, as shown in FIG. 17. Referring to FIG. 18, an example of the millennials personas Todd, “The Borgrammer” profile, matching the motivations towards the different needs featured in the present system, as shown in FIG. 19.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions.

Although specific terms may be employed herein, they are used only in generic and descriptive sense and not for purposes of limitation. Accordingly, the present invention is not limited to the specific embodiments illustrated herein. While the above is a complete description of the preferred embodiments of the invention, various alternatives, modifications, and equivalents may be used. Therefore, the above description and the examples should not be taken as limiting the scope of the invention, which is defined by the appended claims.

1. A computer-implemented system for providing solution to a user with a social network, the computer-implemented system having processor-executable instructions stored thereon that, when executed by at least one processor, the computer-implemented system comprising:
a user module includes a web server system via a network connection configured to control and monitor one or more sub-modules, wherein the user module comprising:
a feed sub-module via a financial management module configured to:
provide access to one or more other users or organizations;
provide access to one or more partner websites selling products or provide services; and
provide a platform for the user to participate in promoting or marketing of one or more product or services, wherein the user receives one or more credits based on the marketing of one or more product or services,
a need sub-module configured to:
provide an option for inputting one or more needs by the user and creating a list of needs for the user;
provide an option of sharing the need or keeping the need private by the user;
provide recommendation to one or more groups related to one or more shared needs;
provide an option for setting up one or more pre-determined user preferences for the need;
filter the recommendations based on the user preferences;
providing an option for the users to join the groups providing one or more solutions to the needs,
wherein the solutions to the needs are judged by the user or other users to generate the credits for a user offering solutions or sharing the solutions to the input needs,
a bid sub-module comprising one or more user accounts managed by the user is configured to:
collect one or more data of the user accounts contributing to a bid;
compute a selling price based on the data of the user accounts;
receive the selling price of the user accounts determined by the user, wherein the user is provided with an option to sell or buy user accounts for generating the credits to the user accounts,
a lead sub-module comprising a neural network configured to learn and track one or more user behavior in the system, wherein the behavior is stored in a database of the system, and the user generates the credits by sharing the behavior to other users.

2. The computer-implemented system of claim 1, wherein the need includes one or more needs of physical, psychological, safety or convenience.

3. The computer-implemented system of claim 1, wherein the credit is one or more rewards comprising a reward point, or a gift voucher, or a cash reward, or one or more discounts.

4. The computer-implemented system of claim 1, wherein the feed sub-module is configured to provide access to the partner websites providing services including dating, traveling, shopping, or gaming.

5. The computer-implemented system of claim 1, wherein the feed sub-module via a financial management module is configured to provide an option for the users to create groups, pages, advertisements.

6. The computer-implemented system of claim 1, wherein the system receives a percentage of transaction, a percentage of profit or a fixed fee from one or more transaction made by the users in the feed module.

7. The computer-implemented system of claim 1, wherein the system is configured to provide an option for the user to customize the feed sub-module to a marketing organization.

8. The computer-implemented system of claim 1, wherein the need sub-module is configured to share one or more internal web pages or external web pages in the server, or groups related to the needs that have been created and recommended by other users in connection with one or more similar input needs of the user.

9. The computer-implemented system of claim 1, wherein the need sub-module is configured to provide an option for the users to search one or more internal web pages or external web pages in the server, or groups related to the needs, which are created and recommended by other users in connection with one or more similar input needs of the user.

10. The computer-implemented system of claim 1, wherein the bid sub-module is configured to provide an option for the user to buy or sell the user account.

11. The computer-implemented system of claim 1, wherein the bid sub-module is configured to compute a selling price of the user account based on one or more data value including records, history, points, or reputations in the user accounts.

12. The computer-implemented system of claim 1, wherein the bid sub-module is configured to provide an option for the other user to provide the data value to the user account.

13. The computer-implemented system of claim 1, wherein the user behavior is one or more methods or experiences of the user fulfilling the needs.

14. The computer-implemented system of claim 1, wherein the lead sub-module comprises an option for users to share one or more methods or experience of fulfilling the needs to other users by providing one or more comments, reviews, or reactions.

15. A computer-readable storage medium having processor-executable instructions stored thereon that, when executed by at least one processors with a web-server system via a network connection to:
provide an access to one or more other users or organizations for the users by a first sub-module;
provide an access to one or more partner websites selling products or providing services by the first sub-module;
provide a platform for the user to participate in promoting or marketing of one or more product or services by the first sub-module, wherein the user receives one or more credits based on the marketing of one or more product or services, provide an option for inputting one or more needs by the user and creating a list of needs for the user by a second sub-module;
provide an option of sharing the need or keeping the need private by the user by the second sub-module;
provide a recommendation to one or more groups related to one or more shared needs by the second sub-module;
provide an option for setting up one or more pre-determined user preferences for the need by the second sub-module;
filter the recommendations based on the user preferences by the second sub-module;
providing an option for the users to join the groups providing one or more solutions to the needs by the user by the second sub-module, wherein the solutions to the needs are judged by the user or other users to generate the credits for a user offering solutions or sharing the solutions to the input needs,
collect one or more data of the user accounts contributing to a bid by a third sub-module;
compute a selling price based on the data of the user accounts by the third sub-module;
receive the selling price of the user accounts determined by the user by the third sub-module, wherein the user is provided with an option to sell or buy user accounts for generating the credits to the user,
learn and track one or more user behavior via a neural network by a fourth sub-module, wherein the behavior is stored in a database of the system, and the user generates the credits by sharing the behavior to other users.

16. The computer-readable storage medium of claim 15, wherein the first sub-module is a feed sub-module, the second sub-module is a need sub-module, the third sub-module is a bid sub-module, and the fourth sub-module is a lead sub-module.

17. A method for online social commercial network implemented with a web-server system via a network connection, the computer-implemented system having processor-executable instructions stored thereon that, when executed by at least one processor, the method comprising:
providing an access to one or more other users or organizations for the users in the network by a first sub-module;
providing an access to one or more partner websites selling products or providing services by the first sub-module;
providing a platform for the user to participate in promoting or marketing of one or more product or services by the first sub-module, wherein the user receives one or more credits based on the marketing of one or more product or services,
providing an option for inputting one or more needs by the user and creating a list of needs for the user by a second sub-module;
providing an option of sharing the need or keeping the need private by the user by the second sub-module;
providing a recommendation to one or more groups related to one or more shared needs by the second sub-module;
providing an option for setting up one or more pre-determined user preferences for the needs by the second sub-module;
filtering the recommendations based on the user preferences by the second sub-module;
providing an option for the users to join the groups providing one or more solutions to the needs by the second sub-module, wherein the solutions to the needs are judged by the user or other users to generate the credits for a user offering solutions or sharing the solutions to the input needs,
collecting one or more data of the user accounts contributing to a bid by a third sub-module;
computing a selling price based on the data of the user accounts by the third sub-module;
receiving the selling price of the user accounts determined by the user, wherein the user is provided with an option to sell or buy user accounts for generating the credits to the user by the third sub-module, and
learning and tracking one or more user behavior via a neural network by a fourth sub-module, wherein the behavior is stored in a database of the system, and the user generates the credits by sharing the behavior to other users.

18. The method of claim 17, wherein the first sub-module is a feed sub-module, the second sub-module is a need sub-module, the third sub-module is a bid sub-module, and the fourth sub-module is a lead sub-module.
